(19) United States
(12) Patent Application Publication
(10) Pub. No.: US 2005/0080626 A1
(43) Pub. Date: Apr. 14, 2005

(54) Voice output device and method

(76) Inventors: Toru Marumoto, Iwaki-city (JP); Nozomu Saito, Iwaki-city (JP)

Correspondence Address: BRINKS HOFER GILSON & LIONE, P.O. BOX 10395, CHICAGO, IL, 60610, US

(21) Appl. No.: 10/925,874

(22) Filed: Aug. 24, 2004

(30) Foreign Application Priority Data
Aug. 25, 2003 (JP) 2003-300071

(51) Int. Cl. G10L 15/00

(52) U.S. Cl. 704/269

(57) ABSTRACT

Voice output device and method to generate voice messages that are highly comprehensible. The voice output device includes a voice database in which information indicating the familiarity level of each word or word string has been recorded, and a sound pressure adjustor for adjusting the sound pressure level of each word or word string on the basis of voice data and familiarity information read together with voice data from the voice database by a reproducer. For a word or the like having low familiarity, the sound pressure thereof is corrected by increasing it. Thus, to generate a voice message including a word of low familiarity, such as an unfamiliar place name, adjustment is performed so that the unfamiliar place name is generated with a higher sound pressure, as compared with a word of high familiarity. This allows words with low familiarity to be easily comprehended.

### BACKGROUND OF THE INVENTION

1. Field of the Invention

The present invention relates to a voice output device and method and, more particularly, to a device and a method ideally used for correcting voices so as to make voice messages from an in-vehicle unit easily comprehensible to a user in a vehicle compartment.

2. Description of the Related Art

In recent years, there has been an increasing demand for voice outputs in vehicle compartments. Such voice outputs include instructions of navigation devices, voices of parties on the phones through hands-free devices, and voices for reading aloud website information received through information communications systems or electronic mail. Systems available for such voice outputs come in two types, one being a recording/reproducing type in which voices recorded beforehand in media, including digital versatile disks (DVD) and hard disks, are reproduced, and the other being a text-to-speech (TTS) type in which voice waveforms are created on the basis of supplied character information.

A voice output device of the latter type, TTS, is roughly divided into two processors, namely, a language processor adapted to add reading and accents to supplied character information according to text analysis dictionary data, and a voice synthesizing unit adapted to generate voices according to waveform/phonemic piece dictionary data.

Hitherto, a voice articulation improving system based on loudness compensation has been proposed in relation to voice output. This system allows an output voice to be heard more clearly in noises by properly adjusting a sound pressure level of the output voice according to a level of an ambient noise or the like input through a microphone (refer to, for example, Japanese Unexamined Patent Application Publication No. 11-166835).

A conventional voice correction device represented by the aforesaid articulation improving system is adapted to correct a sound pressure of a voice message according to physical quantities in an ambient noise environment, including a noise level and a vehicle speed signal. However, even after output voice messages are corrected to make them more articulate on the basis of the physical quantities, it is human beings that hear them and therefore not all words or sentences can be understood substantially at the same level. This is because even if a word has the same sound pressure level, the level of comprehensibility of the word varies, depending on familiarity (recognizability) of the word.

FIG. 5 is a characteristic diagram showing test results that indicate a relationship among word familiarity, word comprehensibility, and sound pressure. This characteristic diagram shows how the comprehensibility of a word changes at different sound pressure levels and also indicates how the comprehensibility of a word changes at different levels of familiarity of the word to be heard. As is obvious from the characteristic diagram, when the sound pressure level remains the same, the comprehensibility of a word rises as the familiarity of the word increases, while the comprehensibility of a word falls as the familiarity of the word decreases.

Thus, when the sound pressure level of an output voice is corrected on the basis of physical quantities, the ease of hearing undesirably varies, depending on the detail of an output voice. This poses a problem in that, for example, aural guide of a navigation device during drive becomes more difficult to comprehend as the unfamiliarity of a place name increases.

As an information processing device adapted to take familiarity of words into account, a Kana-Kanji converting device is available, which displays Kanji conversion candidates arranged in decreasing order of familiarity (refer to, for example, Japanese Unexamined Patent Application Publication No. 2001-216295).

There is also a pattern recognizing device available, which is adapted to search for a word with a higher level of familiarity and output it as a recognition result when there is a plurality of words representing the same concept for a received pattern string (refer to, for example, Japanese Unexamined Patent Application Publication No. 2002-162991).

### SUMMARY OF THE INVENTION

The present invention has been accomplished with a view toward solving the problem described above, and it is an object of the invention to make it possible to provide highly comprehensible voice messages or voice messages that can be easily heard, regardless of the contents of voice messages to be output.

To this end, in a voice output device according to the present invention, information regarding familiarity indicating levels of a plurality of words or word strings is prepared, and a sound pressure level of a voice message to be generated is adjusted by each word or word string on the basis of the familiarity information.

With this arrangement, when a voice message including, for example, an unfamiliar place name, which has low word familiarity, is generated, a higher sound pressure than that for a word with higher familiarity is used to generate it, thus permitting higher comprehensibility of the word to be achieved. This makes it possible to always provide voice messages that ensure high comprehensibility even if an aural message to be generated is composed of a word or word string that has low familiarity or if an aural message to be output includes a mixture of words having high familiarity and words having low familiarity.

### BRIEF DESCRIPTION OF THE DRAWINGS

FIG. 1 is a diagram showing a configuration example of an essential section of a voice output device according to a first embodiment;

FIG. 2 is a diagram showing a configuration example of an essential section of a voice output device according to a second embodiment;

FIG. 3 is a diagram showing a configuration example of an essential section of a voice articulation improving system according to a third embodiment;

FIG. 4 is a diagram showing a configuration example of an essential section of a voice communication system according to a fourth embodiment; and

FIG. 5 is a characteristic diagram showing test results indicative of a relationship among familiarity of words, comprehensibility of words, and sound pressure.

### DESCRIPTION OF THE PREFERRED EMBODIMENTS

First Embodiment

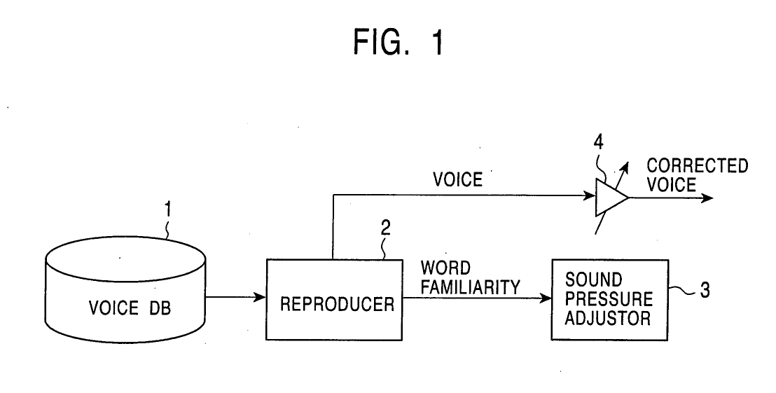

The following will describe a first embodiment according to the present invention in conjunction with the accompanying drawings. The first embodiment has applied the present invention to a voice output device of the recording/reproducing type. FIG. 1 is a diagram showing a configuration example of an essential section of a voice output device according to the first embodiment. Referring to FIG. 1, the voice output device according to the present embodiment is constructed of a voice database (DB) 1, a reproducer 2, a sound pressure adjustor 3, and a control knob 4.

The voice DB 1 is composed of waveform-coded voice data recorded in a medium, such as a DVD or a hard disk. The voice DB 1 includes voice data to be output, which has been recorded on a word or word string basis. A word string refers to a combination of a plurality of words that is likely to be used at the same time or an idiom composed of a plurality of words or a simple sentence. Hereinafter, “a word or word string” will be referred to simply as “a word or the like.”

For instance, to apply the voice output device in accordance with the present embodiment to a navigation device, a guiding message “traffic jam ahead toward ______” is divided by word like |traffic|jam|ahead|toward|______|so as to record each word as a separate voice pattern. To reproduce the guiding message, the plurality of the individual voice patterns, which have been separately recorded, are sequentially read and output.

Furthermore, the voice DB 1 also includes information related to familiarity indicating levels of the individual voice patterns recorded on a basis of a word or the like. The familiarity information indicates the level of word familiarity of each word or the like in terms of numeral values (e.g., 1.0 to 7.0). Thus, the voice DB 1 constitutes the familiarity information storing means in the present invention.

The reproducer 2 reproduces voice data and familiarity information from the voice DB 1. The reproducer 2 arbitrarily selects and reads a plurality of voice patterns from the voice DB 1, that is, selects a tag of a data position where a voice pattern corresponding to a message to be issued has been recorded, and then reads it. This allows a desired message voice to be reproduced. At this time, familiarity information stored in association with the plurality of the read voice patterns is also read.

The sound pressure adjustor 3 controls the control knob 4 according to the familiarity information read from the voice DB 1 by the reproducer 2 so as to adjust the sound pressure level of each voice pattern (each word or the like) also read from the voice DB 1 by the reproducer 2. More specifically, a correction is made to increase the value set on the control knob 4 as the familiarity decreases.

In North Carolina, for example, to output a voice message “traffic jam ahead toward ______,” no adjustment of the value on the control knob 4 is performed if the underlined portion indicates a place name of high familiarity, such as “Charlotte” or “Jacksonville.” If, on the other hand, the underlined portion is a word of low familiarity, such as “Wanchese” or “Zebulon,” then adjustment is performed to increase the value on the control knob.

Furthermore, to output a guiding voice message “turn right at ______” in North Carolina, if the underlined portion indicating a street name is a word of high familiarity, such as “Washington Street” or “Spring Street,” then no adjustment of the value on the control knob 4 is performed. If, on the other hand, the underlined portion indicating a street name is a word of low familiarity, such as “Staya Way” or “Keepa Way,” then adjustment is performed to increase the value on the control knob 4.

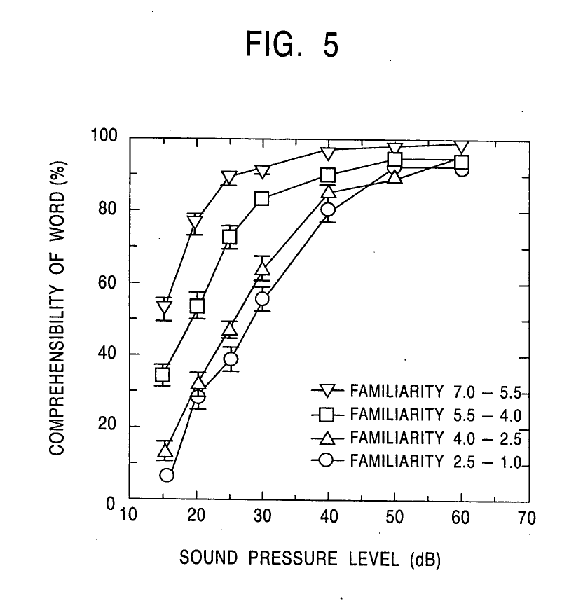

The increase of the value on the control knob 4 preferably depends on the value of word familiarity. For example, in the characteristic diagram in FIG. 5, if it is assumed that word comprehensibility of 80% is to be achieved, then no adjustment of a sound pressure level is necessary for voice patterns of word familiarity ranging from 7.0 to 5.5 if an original sound pressure level is about 20 dB. If voice patterns have word familiarity ranging from 5.5 to 4.0, then the sound pressure levels should be increased about 5 dB. If voice patterns have word familiarity ranging from 4.0 to 2.5, then their sound pressure levels should be increased about 15 dB. If voice patterns have word familiarity ranging from 2.5 to 1.0, then their sound pressure levels should be increased about 20 dB.

As explained in detail above, according to the first embodiment, familiarity information is added to each word or the like and stored in the voice DB 1 in which each word or the like to be generated has been recorded, and the sound pressure level of each word or the like to be generated on the basis of familiarity information read together with voice messages is adjusted, as necessary. Hence, even if voice messages including unfamiliar words or the like are to be generated, it is possible to provide the voice messages with high comprehensibility, that is, great ease of hearing. This means that voice messages can be made always easy to hear by using, for example, a navigation device to which a voice output device according to the present embodiment has been applied, in an unfamiliar area.

In the aforesaid first embodiment, the description has been given of the example wherein the sound pressure level of a word or the like of highest word familiarity is taken as a reference sound pressure level, and sound pressure levels of words or the like having lower word familiarity are corrected by increasing them; the present invention, however, is not limited thereto. Alternatively, for example, the sound pressure level of a word or the like having lowest word familiarity may be taken as the reference sound pressure level, and sound pressure levels of words or the like having higher word familiarity may be corrected by decreasing them. In another alternative, the sound pressure level of a word or the like having medium word familiarity may be taken as the reference sound pressure level, and sound pressure levels of words or the like having higher sound pressure levels than the reference level may be corrected by decreasing them, while those having lower word familiarity than the reference level may be corrected by increasing them so as to adjust the comprehensibility of all words or the like substantially to the same level.

In the aforesaid first embodiment, the description has been given of the example wherein the comprehensibility of all words or the like are adjusted substantially to the same level by adjusting the sound pressure levels according to word familiarity; the present invention, however, is not limited thereto. For example, it is not always necessary to adjust the comprehensibility of all words or the like to substantially the same level as long as the comprehensibility levels of words are adjusted to be larger than a predetermined value by adjusting their sound pressures.

In the first embodiment described above, the description has been given of the example wherein the sound pressure levels of voices are adjusted on the basis of familiarity information. As an alternative, in addition to or in place of the above, a word or the like having a lower word familiarity level than a predetermined value may be repeatedly reproduced twice or more. When a guiding voice message saying, for example, “traffic jam ahead toward Wanchese” is generated, control is carried out such that the sound pressure adjustor 3 makes adjustment to increase the sound pressure level of the portion “Wanchese” and to repeatedly reproduce twice the word or the like having lower word familiarity, e.g., “traffic jam ahead toward Wanchese, toward Wanchese.” Similarly, when a guiding voice message saying “turn right at Staya Way” is generated, control is carried out such that the sound pressure adjustor 3 makes adjustment to increase the sound pressure level of the portion “Staya Way” and to repeatedly reproduce twice the word or the like having lower word familiarity, e.g., “turn right at Staya Way, Staya Way.” The control for repetitive reproduction can be accomplished by the reproducer 2. Thus, the comprehensibility of less familiar words or the like can be improved by repetitive reproduction.

In addition to or in place of adjusting the sound pressure levels of voices on the basis of familiarity information, the reproducing speed of voices may be adjusted. When a guiding voice message saying, for example, “traffic jam ahead toward Wanchese” is generated, control is carried out such that the sound pressure adjustor 3 makes adjustment to increase the sound pressure level of the portion “Wanchese” and to reproduce the portion “Wanchese” more slowly than that for the rest. Similarly, when a guiding voice message saying “turn right at Staya Way” is generated, control is carried out such that the sound pressure adjustor 3 makes adjustment to increase the sound pressure level of the portion “Staya Way” and to reproduce the portion “Staya Way” more slowly than for the rest. The control of the reproducing speed can be accomplished by the reproducer 2. Thus, the comprehensibility of less familiar words or the like can be improved by lowering reproducing speed.

In addition to or in place of adjusting the sound pressure levels of voices on the basis of familiarity information, words or the like having word familiarity levels that are lower than a predetermined value may be displayed on a screen. The display control is possible by using a display controller, not shown, (e.g., a display controller provided as a standard device for displaying map images or the like on a display device in the case of a navigation device). Thus, the comprehensibility of less familiar words or the like can be improved by displaying them on a screen for visual check.

Second Embodiment

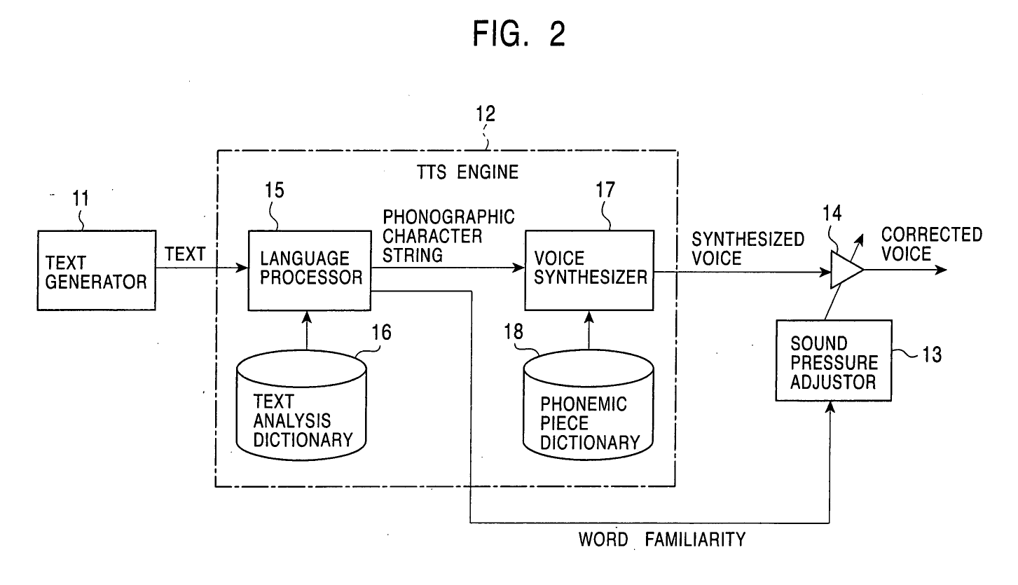

A second embodiment according to the present invention will now be described in conjunction with the accompanying drawings. In the second embodiment, the present invention has been applied to a TTS type voice output device. FIG. 2 is a diagram illustrating a configuration example of an essential section of a voice output device according to the second embodiment. As shown in FIG. 2, the voice output device according to the second embodiment is constructed of a text generator 11, a TTS engine 12, a sound pressure adjustor 13, and a control knob 14.

The text generator 11 generates text information representing voice messages to be generated in the form of character strings. The text generator 11 may be of a type in which text information of an arbitrary character string is manually generated by a user who operates a keyboard (not shown), or a type in which a controller automatically generates text information of an arbitrary character string according to a predetermined rule.

The TTS engine 12 is constituted by a language processor 15, a text analysis dictionary 16, a voice synthesizer 17, and a phonemic piece dictionary 18. The text analysis dictionary 16 is a dictionary database for text analysis in which text information composed of various types of words or the like is stored in association with phonemic information and metrical information to be added to the above words or the like.

The text analysis dictionary 16 also includes recorded familiarity information related to a word or the like that is added to each piece of text information recorded on the basis of word or the like. The familiarity information indicates the familiarity of each word or the like in terms of a numerical value (e.g., 1.0 to 7.0). Thus, the text analysis dictionary 16 constitutes the familiarity information storing means of the present invention.

The language processor 15 refers to the text analysis dictionary 16 on the basis of text information received from the text generator 11, and generates phonogramic character string information by adding associated phonemic information and metrical information to the character string of a word or the like indicated by the text information. At this time, the language processor 15 reads familiarity information stored in association with the received text information.

The phonemic piece dictionary 18 is a phonemic piece dictionary database in which waveform information to be added to character strings in units of the character strings composed of various types of words or the like has been stored. Based on the information of a phonogramic character string produced by the language processor 15, the voice synthesizer 17 refers to the phonemic piece dictionary 18 to process the phonogramic character string by using waveform information, thereby to generate a synthesized voice.

The sound pressure adjustor 13 controls the control knob 14 according to the familiarity information extracted from the text analysis dictionary 16 by the language processor 15 to adjust the sound pressure level of the synthesized voice generated by the voice synthesizer 17. For instance, the sound pressure of a word or the like having highest word familiarity is taken as a reference sound pressure level, and a correction is made to increase the control knob value of a word or the like having word familiarity that is lower than the reference sound pressure level. The increase of the control knob value preferably depends on the value of word familiarity, as in the case of the first embodiment.

As explained in detail above, according to the second embodiment, familiarity information is stored by being added to each word or the like to the text analysis dictionary 16 provided in the TTS engine 12 that synthesizes voice waveforms according to supplied text information and then reproduces it. The sound pressure level of each word or the like to be output is appropriately adjusted on the basis of familiarity information extracted when analyzing text information. Hence, even when voice messages saying unfamiliar words or the like are to be generated, the voice messages can be made highly comprehensible (easy to hear). This means that, for example, a navigation device to which a voice output device according to the present embodiment has been applied is ideally used in an unfamiliar area to allow guiding voice messages to be always heard easily.

In the above second embodiment also, the description has been given of the example wherein the sound pressure level of a word or the like of highest word familiarity is taken as a reference sound pressure level, and sound pressure levels of words or the like having lower word familiarity are corrected by increasing them; the present invention, however, is not limited thereto. Alternatively, for example, the sound pressure level of a word or the like having lowest word familiarity may be taken as the reference sound pressure level, or the sound pressure level of a word or the like having medium word familiarity may be taken as the reference sound pressure level.

Furthermore, in the aforesaid second embodiment, it is not always necessary to adjust the comprehensibility of all words or the like to substantially the same level by adjusting sound pressure levels according to word familiarity, as long as the comprehensibility levels of words are adjusted to be larger than a predetermined value by adjusting their sound pressure levels.

In the second embodiment described above, the description has been given of the example wherein the sound pressure levels of voice messages are adjusted on the basis of familiarity information. Alternatively, in addition to or in place of the above, a word or the like having a lower word familiarity level than a predetermined value may be repeatedly reproduced twice or more. The control for repetitive reproduction can be accomplished by, for example, the voice synthesizer 17 repeatedly synthesizing the same word or the like twice.

In addition to or in place of adjusting the sound pressure levels of voice messages on the basis of familiarity information, the reproducing speed of voices may be adjusted. The control of the reproducing speed can be accomplished by making the output timing variable for the voice synthesizer 17 to generate synthesized voices.

In addition to or in place of adjusting the sound pressure levels of voices on the basis of familiarity information, words or the like having word familiarity levels that are lower than a predetermined value may be displayed on a screen. The display control is possible by using a display controller, not shown, (e.g., a display controller provided as a standard device for displaying map images or the like on a display device in the case of a navigation device).

Third Embodiment

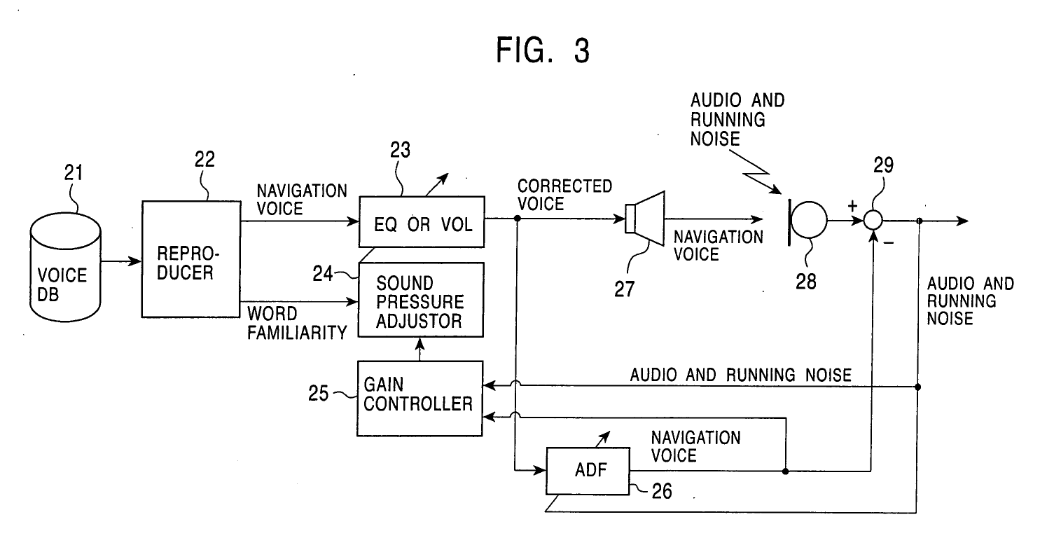

A third embodiment according to the present invention will now be described in conjunction with the accompanying drawings. The third embodiment has applied the present invention to a voice articulation improving system using a loudness compensation technique. FIG. 3 illustrates a configuration example of an essential section of the voice articulation improving system according to the third embodiment.

Referring to FIG. 3, the voice articulation improving system according to the present embodiment includes a voice DB 21, a reproducer 22, a control knob or an equalizer (hereinafter referred to simply as the “control knob or the like”) 23, a sound pressure adjustor 24, a gain controller 25, an adaptive filter (ADF) 26, a speaker 27, a microphone 28, and a subtractor 29.

The voice DB 21 is composed of waveform-coded voice data recorded in a medium, such as a DVD or a hard disk. The voice DB 21 includes voice data to be output, which has been recorded on a word or word string basis. For instance, to apply the voice articulation improving system according to the present embodiment to a navigation device, a voice message “traffic jam ahead toward ______” is divided by each word, e.g., |traffic|jam|ahead|toward|______| so as to record each word as a separate voice pattern. Similarly, a voice message “turn right at ______” is divided by each word, e.g., |turn|right| at |______| so as to record each word as a separate voice pattern.

Furthermore, the voice DB 21 also includes recorded familiarity information added to the individual voice patterns recorded on the basis of word or the like. The familiarity information indicates the level of word familiarity of each word or the like in terms of numeral values (e.g., 1.0 to 7.0). Thus, the voice DB 21 constitutes the familiarity information storing means in the present invention.

The reproducer 22 reproduces voice data and familiarity information from the voice DB 21. The reproducer 22 arbitrarily selects and reads a plurality of voice patterns from the voice DB 21, that is, selects a tag of a data position where a voice pattern corresponding to a message to be issued has been recorded, and then reads it. This allows the guiding voice of a desired message to be reproduced. At this time, familiarity information stored in association with the plurality of the read voice patterns is also read.

The control knob or the like 23 controls the volume of navigation voice messages reproduced by the reproducer 22. The speaker 27 generates navigation voice messages whose sound pressure levels have been corrected by the control knob or the like 23. The microphone 28 is for receiving speech voices. The same microphone 28, however, also receives navigation voice messages generated from the speaker 27, audio sounds generated from another speaker (not shown), running noises (the audio sounds and the running noises will be hereinafter collectively referred to as “ambient noises”), etc. in addition to speech voice commands.

The adaptive filter 26 is constructed of a coefficient identifier and a voice correction filter. The coefficient identifier is a filter for identifying a transfer function (a filter coefficient of the voice correction filter) of an acoustic system from the speaker 27 to the microphone 28, and it uses an adaptive filter based on a least mean square (LMS) algorithm or a normalized-LMS (N-LMS) algorithm. The coefficient identifier operates to minimize the power of error signals (to be discussed later) generated from the subtractor 29 so as to identify impulse responses of the acoustic system.

The voice correction filter uses a filter coefficient determined by the coefficient identifier and a navigation voice message with a corrected sound pressure to be controlled to carry out convoluted operations thereby to impart the same transfer characteristic as the aforesaid acoustic system to the navigation voice message with the corrected sound pressure. This generates a simulated navigation voice that simulates a navigation voice message at the position of the microphone 28.

The subtractor 29 subtracts the simulated navigation voice generated by the adaptive filter 26 from a voice input through the microphone 28, i.e., a voice composed of a mixture of a navigation voice and an ambient noise, so as to extract the ambient noise. The ambient noise extracted by the subtractor 29 is fed back as an error signal to the coefficient identifier of the adaptive filter 26 and the gain controller 25.

Based on the simulated navigation voice generated from the adaptive filter 26 and the ambient noise generated from the subtractor 29, the gain controller 25 calculates an optimum gain to be added to the navigation voice to be controlled and reproduced by the reproducer 22, and sends the calculated gain value to the sound pressure adjustor 24. In this case, the ambient noise (the error signal) is regarded as a noise to the navigation voice, and the gain of the navigation voice is adjusted so that the navigation voice generated from the speaker 27 will be clearly heard. Thus, the gain controller 25 constitutes the gain calculating means in the present invention.

The sound pressure adjustor 24 controls the control knob or the like 23 on the basis of the correction gain calculated by the gain controller 25, and performs comprehensive adjustment of a sound pressure level of the navigation voice message to be generated. The sound pressure adjustor 24 also controls the control knob or the like 23 according to familiarity information read from the voice DB 21 by the reproducer 22, and adjusts the sound pressure level of the navigation voice message to be generated on the basis of word or the like. For example, the sound pressure level of a word or the like having highest word familiarity is taken as the reference sound pressure level, and a value on the control knob is corrected by increasing it for a word or the like having word familiarity that is lower than that.

For instance, to generate a navigation voice message “traffic jam ahead toward ______,” the value on the control knob is increased for the entire navigation voice message to ensure that the navigation voice will be clearly heard even in the presence of ambient noises. Moreover, if the underlined portion indicating a place name is a word with low word familiarity, e.g., “Wanchese” or “Zebulon,” then the value on the control knob is adjusted to provide further compensation for that particular word portion.

To generate a navigation voice message “turn right at ______,” the value on the control knob is increased for the entire navigation voice message to ensure that the navigation voice message will be clearly heard even in the presence of ambient noises. Moreover, if the underlined portion indicating a street name is a word with low word familiarity, e.g., “Staya Way” or “Keepa Way,” then the value on the control knob is adjusted to provide further compensation for that particular word portion. As in the first embodiment, an increase of the value on the control knob for each word or the like preferably depends on the value of word familiarity.

As explained in detail above, according to the third embodiment, voice compensation amounts are appropriately adjusted on the basis of word or the like according to word familiarity information in the loudness compensation type voice articulation improving system. Hence, voice messages to be generated can be clearly heard despite ambient noises, and even if voice messages using unfamiliar words are generated, they can be made easy to hear. Thus, guiding voices will be always easily heard by using, for example, a navigation device, to which the voice articulation improving system has been applied, in an unfamiliar area.

In the above third embodiment also, the description has been given of the example wherein the sound pressure level of a word or the like of highest word familiarity is taken as a reference sound pressure level, and sound pressure levels of words or the like having lower word familiarity are corrected by increasing them; the present invention, however, is not limited thereto. Alternatively, for example, the sound pressure level of a word or the like having lowest word familiarity may be taken as the reference sound pressure level, or the sound pressure level of a word or the like having medium word familiarity may be taken as the reference sound pressure level.

Furthermore, in the aforesaid third embodiment, it is not always necessary to adjust the comprehensibility of all words or the like to substantially the same level by adjusting sound pressure levels according to word familiarity, as long as the comprehensibility levels of words are adjusted to be larger than a predetermined value by adjusting their sound pressures.

In the aforesaid third embodiment also, the description has been given of the example wherein the sound pressure levels of voices are adjusted on the basis of familiarity information. Alternatively, in addition to or in place of the above, a word or the like having a lower word familiarity level than a predetermined value may be repeatedly reproduced twice or more. The control for the repetitive reproduction can be accomplished by the reproducer 22.

In addition to or in place of adjusting the sound pressure levels of voices on the basis of familiarity information, the reproducing speed of voices may be adjusted. The control of the reproducing speed can be accomplished also by the reproducer 22.

In addition to or in place of adjusting the sound pressure levels of voices on the basis of familiarity information, words or the like having word familiarity levels that are lower than a predetermined value may be displayed on a screen. The display control is possible by using a display controller, not shown, (e.g., a display controller provided as a standard device for displaying map images or the like on a display device in the case of a navigation device).

Fourth Embodiment

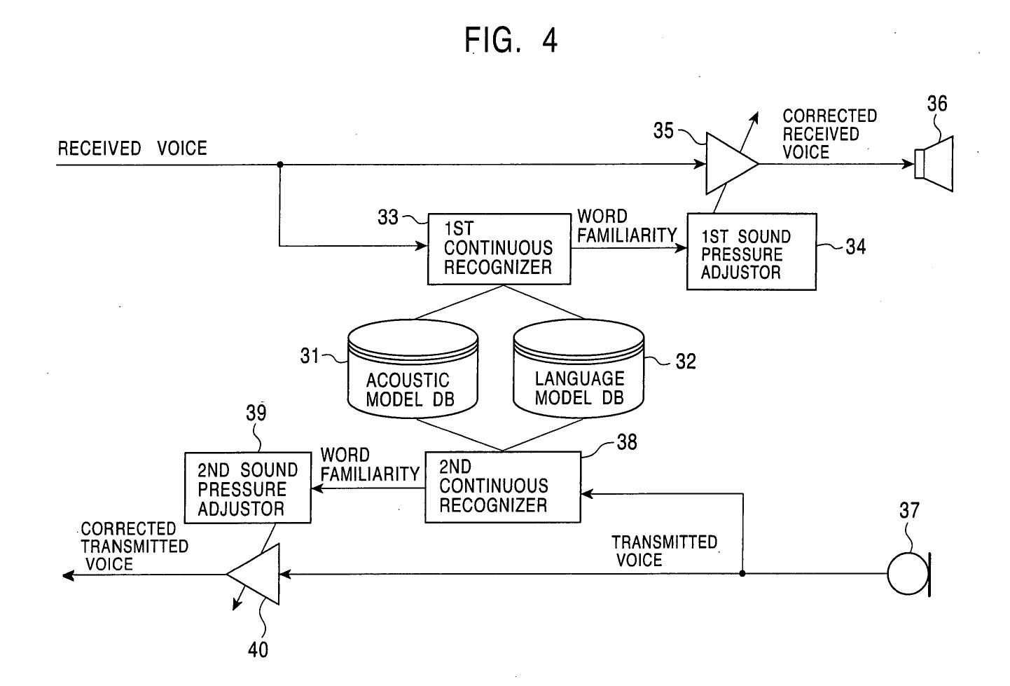

A fourth embodiment according to the present invention will now be described in conjunction with the accompanying drawings. The fourth embodiment has applied the present invention to a voice communication system (e.g., a hands-free system). FIG. 4 illustrates a configuration example of an essential section of the voice communication system according to the fourth embodiment.

Referring to FIG. 4, the voice communication system in accordance with the present embodiment is constructed of an acoustic model DB 31, a language model DB 32, a first continuous recognizer 33, a first sound pressure adjustor 34, a first control knob 35, a speaker 36, a microphone 37, a second continuous recognizer 38, a second sound pressure adjustor 39, and a second control knob 40.

The acoustic model DB 31 is a voice dictionary database including character strings of individual words or the like to be recognized that are stored in association with characteristic amounts of voice patterns thereof. The language model DB 32 is a syntax analysis dictionary database storing information necessary to analyze the syntax of a recognized voice pattern. Stored also in the language model DB 32 is text information representing character strings of various types of words or the like and information indicating familiarity thereof. Thus, the language model DB 32 constitutes the familiarity information storing means in the present invention.

The first continuous recognizer 33 calculates a characteristic amount from a received voice, and then compares the calculated characteristic amount with the characteristic amount of each word or the like stored beforehand in the acoustic model DB 31 to search for a voice pattern with highest similarity, thereby recognizing a character string having that particular voice pattern as the character string of the received voice. Subsequently, the received voice that has been input is converted into text information of the recognized character string. Thus, the first continuous recognizer 33 constitutes the first voice recognizing means in the present invention.

The first continuous recognizer 33 refers to the language model DB 32 on the basis of the converted text information to read the familiarity information stored in association with the text information, and then supplies it to the first sound pressure adjustor 34. The first sound pressure adjustor 34 controls the first control knob 35 on the basis of the familiarity information supplied from the first continuous recognizer 33 so as to adjust the sound pressure level of the received voice message by each word or the like. For instance, the sound pressure level of a word or the like having highest word familiarity is set as the reference sound pressure level, and a correction is made by increasing a value on the control for a word or the like having word familiarity that is lower than the reference level. The received voice message with its sound pressure corrected as described above is generated through the speaker 36.

The second continuous recognizer 38 calculates a characteristic amount from an input voice to be transmitted through the microphone 37, and then compares the calculated characteristic amount with the characteristic amount of each word or the like stored beforehand in the acoustic model DB 31 to search for a voice pattern with highest similarity, thereby recognizing a character string having that particular voice pattern as the character string of the voice to be transmitted. Subsequently, the voice to be transmitted that has been input is converted into text information of the recognized character string. Thus, the second continuous recognizer 38 constitutes the second voice recognizing means in the present invention.

The second continuous recognizer 38 refers to the language model DB 32 on the basis of the converted text information to read the familiarity information stored in association with the text information, and then supplies it to the second sound pressure adjustor 39. The second sound pressure adjustor 39 controls the second control knob 40 on the basis of the familiarity information supplied from the second continuous recognizer 38 so as to adjust the sound pressure level of the voice message to be transmitted by each word or the like. For instance, the sound pressure level of a word or the like having highest word familiarity is set as the reference sound pressure level, and a correction is made by increasing a value on the control for a word or the like having word familiarity that is lower than the reference level. The voice message to be transmitted with its sound pressure corrected as described above is transmitted to the party on the other end.

In the example shown in FIG. 4, both the receiver and the transmitter are provided with the continuous recognizers and the sound pressure adjustors. This makes it possible to provide communication voices of sound pressures appropriately adjusted according to speech details for both transmission and reception even if a voice communication system of the party on the other end is not provided with the same configuration shown in FIG. 4. In the present invention, however, it is not always necessary to provide both receiver and transmitter with the continuous recognizers and the sound pressure adjustors. Alternatively, only either the receiver or the transmitter may be provided with the continuous recognizer and the sound pressure adjustor in the present invention.

When both a receiver and a transmitter have the continuous recognizers and the sound pressure adjustors, if the party on the other end has the same configuration, then a voice that has undergone sound pressure adjustment on the transmitter of one party will be subjected to another sound pressure adjustment by the receiver of the party on the other end, resulting in over-adjustment of the sound pressure. To avoid this, therefore, predetermined communication is carried out to determine whether the party on the other end is equipped with the sound pressure adjustor before starting communication, namely, at a first call. If it is determined that the party on the other end has the sound pressure adjustor, then it is possible to suspend the function of at least one of the first sound pressure adjustor 34 and the second sound pressure adjustor 39.

For example, when making a first phone call, the voice communication system of a calling party sends an inquiry signal to the voice communication system of a called party to inquire whether the called party is equipped with the sound pressure adjustor. In response to the reply, the system of the called party sends back a reply indicating whether it has the sound pressure adjustor. Upon receipt of a reply indicating that the system of the called party has the sound pressure adjustor, the system of the calling party carries out control so as to disable the first sound pressure adjustor 34 in the system of the calling party. Further control is carried out to also disable the first sound pressure adjustor 34 in the system of the called party by sending a signal for instructing functional suspension of the first sound pressure adjustor 34 in the system of the called party.

Alternatively, control may be conducted to disable the second sound pressure adjustor 39 of the system of the calling party and the second sound pressure adjustor 39 of the system of the called party if the system of the calling party receives a response indicating the presence of the sound pressure adjustor from the system of the called party. In another alternative, control may be conducted to disable the first sound pressure adjustor 34 and the second sound pressure adjustor 39 of the system of the calling party, and not to disable the system of the called party. In yet another alternative, control may be conducted to set an increase/decrease width of sound pressure to about half a standard increase/decrease width, without disabling the sound pressure adjustors 34 and 39 of the systems of the calling party and the called party.

As explained in detail above, according to a fourth embodiment, communication voices are recognized and subjected to syntax analysis and sound pressures are appropriately adjusted on the basis of a word or the like according to word familiarity information by using the results of the analyses in the voice communication systems. Hence, even if speech during a call includes unfamiliar words, they can be made easy to hear by correcting their sound pressures, thus permitting comfortable calls at all times.

In the fourth embodiment described above also, the description has been given of the example wherein the sound pressure level of a word or the like of highest word familiarity is taken as a reference sound pressure level, and sound pressure levels of words or the like having lower word familiarity are corrected by increasing them; the present invention, however, is not limited thereto. Alternatively, for example, the sound pressure level of a word or the like having the lowest word familiarity may be taken as the reference sound pressure level, or the sound pressure level of a word or the like having medium word familiarity may be taken as the reference sound pressure level.

Furthermore, in the aforesaid fourth embodiment, it is not always necessary to adjust the comprehensibility of all words or the like to substantially the same level by adjusting sound pressure levels according to word familiarity, as long as the comprehensibility levels of words are adjusted to be larger than a predetermined value by adjusting their sound pressures.

In the aforesaid fourth embodiment also, the description has been given of the example wherein the sound pressure levels of voices are adjusted on the basis of familiarity information. Alternatively, in addition to or in place of the above, a word or the like having a lower word familiarity level than a predetermined value may be repeatedly reproduced twice or more. The control for the repetitive reproduction can be accomplished, for example, as described below. Received voices or voices to be transmitted are digitized to temporarily store them in a buffer memory to repeatedly read them twice or more, and then the read voices are converted back to analog signals.

In addition to or in place of adjusting the sound pressure levels of voices on the basis of familiarity information, the reproducing speed of voices may be adjusted on the basis of word familiarity. The control of the reproducing speed can be accomplished, for example, as described below. Received voices or voices to be transmitted are digitized to temporarily store them in a buffer memory to make the time for reading them from the buffer memory variable according to word familiarity.

In addition to or in place of adjusting the sound pressure levels of voices on the basis of familiarity information, words or the like having word familiarity levels that are lower than a predetermined value may be displayed on a screen. The display control is possible by using a display controller, not shown, (e.g., a display controller provided as a standard device for displaying telephone numbers or the like on a display device).

The techniques for adjusting sound pressures according to the first through the fourth embodiments explained above can be effected also by means of hardware, DSP, or software. For instance, to implement the techniques using software, the voice output devices according to the present embodiments are actually provided with computer CPUs, MPUs, RAMs, ROMs or the like, and programs stored in RAMs or ROMs are run to effect the techniques.

Accordingly, the techniques can be implemented by recording programs for causing computers to carry out the functions of the aforesaid embodiments in recording media, such as CD-ROMs, and causing the computers to read the programs. Available recording media for recording the aforesaid programs include flexible disks, hard disks, magnetic tapes, optical disks, magneto-optical disks, DVDs, and non-volatile memory cards, in addition to CD-ROMs. The techniques can also be implemented by downloading the aforesaid programs into computers via networks, such as the Internet.

The first through the fourth embodiments merely illustrate some examples of implementation of the present invention, and are not to be construed to limit the technological scope of the present invention. In other words, the present invention can be implemented in diverse forms without departing from the spirit or essential characteristics thereof.

The voice output device and method in accordance with the present invention can be extensively applied to an apparatus or a system for adjusting sound pressures on the basis of a word or the like according to familiarity. The voice output device and method in accordance with the present invention can be suitably used, for example, with the navigation devices or the voice communication systems described in the above embodiments. The voice output device and method in accordance with the present invention can be also suitably used with an information communication device for reading aloud website information or electronic mail received through information networks, such as the Internet. In addition, the voice output device and method according to the present invention are useful for adjusting sound pressures of unfamiliar words or the like, difficult words or the like, and words or the like that are difficult to pronounce in a language learning system adapted to read aloud conversations, words or the like.

1. A voice generating device comprising:
information storing means that stores familiarity information indicating a level of familiarity of a plurality of words or word strings; and
sound pressure adjusting means for adjusting sound pressure levels of the words or word strings to be generated on the basis of the familiarity information stored in the information storing means.

2. The voice generating device according to claim 1, wherein the information storing means is constructed of a voice database in which the words or word strings to be generated have been previously recorded, the familiarity information having been added on a word or word string basis to the voice database.

3. The voice generating device according to claim 1, wherein the information storing means is constructed of the familiarity information added on a word or word string basis to a text analysis dictionary database included in a device that synthesizes and reproduces a voice waveform based on supplied text information.

4. The voice generating device according to claim 1, further comprising:
gain calculating means for calculating a correction gain of the voice generated on the basis of a sound pressure level of a generated voice message and a sound pressure level of an ambient sound audible at a position where the generated voice message is heard,
wherein the sound pressure adjusting means adjusts a sound pressure level of a voice message to be generated on the basis of a correction gain calculated by the gain calculating means, and adjusts, on a word or word string basis, the sound pressure level of the voice message to be generated according to familiarity information stored in the information storing means.

5. The voice generating device according to claim 1, further comprising:
voice recognizing means for checking an input voice message against a voice dictionary prepared in advance to recognize a word or word string related to the input voice message, and converting the input voice message into text information,
wherein the information storing means stores information showing a relationship between text information indicating a plurality of words or word strings and the familiarity thereof, and
the sound pressure adjusting means adjusts a sound pressure level of the input voice on a word or word string basis according to the familiarity information obtained by referring to the information storing means according to the text information converted by the voice recognizing means.

6. The voice generating device according to claim 5, wherein the voice recognizing means receives an input voice message in a voice communication system and checks the input voice message against a voice dictionary prepared in advance so as to recognize a word or word string related to the input voice message, and then converts the input voice message into text information.

7. The voice generating device according to claim 5, wherein the voice recognizing means receives a transmitted voice message in a voice communication system and checks the transmitted voice message against a voice dictionary prepared in advance so as to recognize a word or word string related to the transmitted voice message, and then converts the transmitted voice message into text information.

8. The voice generating device according to claim 5, wherein
the voice recognizing means comprises:
first voice recognizing means that receives an input voice message in a voice communication system and checks the input voice message against a voice dictionary prepared in advance so as to recognize a word or word string related to the input voice message, and then converts the input voice message into text information; and
second voice recognizing means that receives a transmitted voice message in the voice communication system and checks the transmitted voice message against a voice dictionary prepared in advance so as to recognize a word or word string related to the transmitted voice message, and then converts the transmitted voice message into text information,
wherein the sound pressure adjusting means comprises:
first sound pressure adjusting means that adjusts a sound pressure level of the received voice message on a word or word string basis according to the familiarity information obtained from the information storing means based upon the text information converted by the first voice recognizing means; and
second sound pressure adjusting means that adjusts a sound pressure level of the transmitted voice message on a word or word string basis according to the familiarity information obtained from the information storing means based upon the text information converted by the second voice recognizing means.

9. The voice generating device according to claim 8, further comprising:
determining means for determining whether the other communication device has a sound pressure adjusting means before communication is commenced; and
controlling means for disabling at least one of the first sound pressure adjusting means and the second sound pressure adjusting means if the determining means determines that the other communication party has a sound pressure adjusting means.

10. The voice generating device according to claim 1, further comprising reproduction controlling means for repeatedly reproducing twice or more a word or word string whose familiarity is lower than a predetermined value on the basis of the familiarity information stored in the information storing means.

11. The voice generating device according to claim 1, further comprising reproduction controlling means for adjusting the reproduction rate of the word or word string to be generated on the basis of the familiarity information stored in the information storing means.

12. The voice generating device according to claim 1, further comprising display controlling means for controlling the display of a word or word string whose familiarity is lower than a predetermined value on the basis of the familiarity information stored in the information storing means.

13. A voice generating method wherein a sound pressure adjusting unit refers to familiarity information representing the level of familiarity of a plurality of words or word strings so as to adjust a sound pressure level of each word or word string to be generated on the basis of the familiarity information.

14. The voice generating method according to claim 13, wherein the sound pressure adjusting unit refers to the familiarity information recorded in the voice database on a word or word string basis so as to adjust the sound pressure level of a voice message to be reproduced on a word or word string basis when reproducing a voice message from a voice database in which the word or word string to be generated has been recorded.

15. The voice generating method according to claim 13, wherein the sound pressure adjusting unit refers to the familiarity information recorded on a word or word string basis in a text analysis dictionary database so as to adjust, on a word or word string basis, the sound pressure level of a voice message to be reproduced when synthesizing voice waveforms according to supplied text information and then reproducing the voice message.

16. The voice generating method according to claim 13, wherein, when reproducing an externally received voice message, a voice recognizing unit checks the received voice message against a voice dictionary prepared in advance to recognize a word or word string related to the received voice message, and the sound pressure adjusting unit refers to the familiarity information associated with the recognized word or word string so as to adjust, on a word or word string basis, the sound pressure level of the voice message to be reproduced.

17. The voice generating method according to claim 13 in a voice articulation improving system for determining a correction gain on the basis of a sound pressure level of a generated voice message and a sound pressure level of an ambient sound audible at a position where the generated voice message is heard so as to correct the sound pressure level of the generated voice message on the basis of the correction gain,
wherein the sound pressure adjusting unit adjusts the sound pressure level of the generated voice message on the basis of the correction gain, and adjusts the sound pressure level of each word or word string of the generated voice message according to the familiarity information.

18. The voice generating method according to claim 13, wherein a word or word string whose familiarity is lower than a predetermined value is repeatedly reproduced and generated twice or more on the basis of the familiarity information.

19. The voice generating method according to claim 13, wherein, based on the familiarity information, a word or word string whose familiarity is lower than a predetermined value is reproduced at a rate lower than that for a word or word string whose familiarity is the predetermined value or more.

20. The voice generating method according to claim 13, wherein a word or word string whose familiarity is lower than a predetermined value is displayed on a screen on the basis of the familiarity information.

21. A voice generating method comprising:
receiving a voice message;
comparing the received voice message against a voice dictionary prepared in advance to recognize a word or word string related to the received voice message;
providing familiarity information associated with the recognized word or word string; and
adjusting the sound pressure level of each word or word string to be generated on the basis of the familiarity information.
